(19) United States
(12) Patent Application Publication
(10) Pub. No.: US 2023/0146671 A1
(43) Pub. Date: May 11, 2023

(54) INFORMATION BROWSING SYSTEM, INFORMATION BROWSING DEVICE, INFORMATION BROWSING METHOD, AND COMPUTER-READABLE NON-TRANSITORY STORAGE MEDIUM STORING PROGRAM THEREIN

(71) Applicant: HONDA MOTOR CO., LTD., Tokyo (JP)

(72) Inventors: Satoru OJIMA, TOKYO (JP); Katsunori TAGUCHI, TOKYO (JP)

(21) Appl. No.: 17/977,052

(22) Filed: Oct. 31, 2022

(30) Foreign Application Priority Data
Nov. 5, 2021 (JP) 2021-181267
Nov. 5, 2021 (JP) 2021-181271

(51) Int. Cl. G06F 16/28; G06F 16/2457; G06F 16/23

(52) U.S. Cl. CPC G06F 16/287; G06F 16/24573; G06F 16/2365

(57) ABSTRACT

An information browsing system includes a data-reduced-information storage unit that stores therein data-reduced information obtained by reducing data volume of product information, an accepting unit that accepts a presentation of a browsing ticket from a browsing person, and a browsing processing unit which, in the case that the browsing ticket has been accepted by the accepting unit, allows the browsing person to browse the data-reduced information corresponding to the product information specified by the browsing ticket.

### CROSS-REFERENCE TO RELATED APPLICATIONS

This application is based upon and claims the benefit of priority from Japanese Patent Applications No. 2021-181267 filed on Nov. 5, 2021 and No. 2021-181271 filed on Nov. 5, 2021, the contents all of which are incorporated herein by reference.

### BACKGROUND OF THE INVENTION

### Field of the Invention

The present invention relates to an information browsing system, an information browsing device, an information browsing method, and a computer-readable non-transitory storage medium storing a program therein.

### Description of the Related Art

In JP 2007-072937 A, a construction information distribution system is disclosed in which CAD (Computer-Aided Design) data and the like is distributed from a home page. In JP 2007-072937 A, information security is ensured by way of authentication using an authentication key.

### SUMMARY OF THE INVENTION

However, in the case that the size of the data is relatively large, a long time is required to communicate the data. Further, in the case that application software or the like, which is used when the data is generated, is not installed in the device that has received the data, there are cases in which such data is incapable of being browsed. Further, in the case that the data is revised or the like, a concern arises in that a browsing person who browses the data may be allowed to browse data for which a revision thereof differs from the data that should be browsed by the browsing person.

The present invention has the object of solving the aforementioned problem.

An information browsing system according to one aspect of the present invention includes a data-reduced-information storage unit configured to store data-reduced information obtained by reducing data volume of product information, an accepting unit configured to accept a presentation of a browsing ticket from a browsing person, and a browsing processing unit configured to, in a case that the browsing ticket has been accepted by the accepting unit, allow the browsing person to browse the data-reduced information corresponding to the product information specified by the browsing ticket.

An information browsing system according to another aspect of the present invention includes an issuing unit configured to issue a browsing ticket that serves to allow a browsing person to browse product information, and a transmission unit configured to transmit the browsing ticket issued by the issuing unit to the browsing person, wherein the browsing ticket includes a plurality of indexes in order to specify the product information that is an object to be browsed by the browsing person, and the plurality of indexes include an index that serves to specify a revision of the product information that is the object to be browsed by the browsing person.

An information browsing device according to still another aspect of the present invention includes an accepting unit configured to accept a presentation of a browsing ticket from a browsing person, and a browsing processing unit configured to, in a case that the browsing ticket has been accepted by the accepting unit, allow the browsing person to browse data-reduced information corresponding to product information specified by the browsing ticket, wherein the data-reduced information is obtained by reducing data volume of the product information.

An information browsing device according to yet another aspect of the present invention includes an issuing unit configured to issue a browsing ticket that serves to allow a browsing person to browse product information, wherein the browsing ticket includes a plurality of indexes in order to specify the product information that is an object to be browsed by the browsing person, and the plurality of indexes include an index that serves to specify a revision of the product information that is the object to be browsed by the browsing person.

An information browsing method according to still another aspect of the present invention includes a step of accepting a presentation of a browsing ticket from a browsing person, and a step of, in a case that the browsing ticket has been accepted, allowing the browsing person to browse data-reduced information corresponding to product information specified by the browsing ticket, wherein the data-reduced information is obtained by reducing data volume of the product information.

An information browsing method according to yet another aspect of the present invention includes a step of issuing a browsing ticket that serves to allow a browsing person to browse product information, and a step of transmitting the issued browsing ticket to the browsing person, wherein the browsing ticket includes a plurality of indexes in order to specify the product information that is an object to be browsed by the browsing person, and the plurality of indexes include an index that serves to specify a revision of the product information that is the object to be browsed by the browsing person.

In a computer-readable non-transitory storage medium storing a program therein according to still another aspect of the present invention, the program causes a computer to execute a process including: accepting a presentation of a browsing ticket from a browsing person; and allowing the browsing person to browse data-reduced information corresponding to product information specified by the browsing ticket, in a case that the browsing ticket has been accepted, the data-reduced information being obtained by reducing data volume of the product information.

In a computer-readable non-transitory storage medium storing a program therein according to yet another aspect of the present invention, the program causes a computer to execute a process including: issuing a browsing ticket that serves to allow a browsing person to browse product information; and transmitting the issued browsing ticket to the browsing person, wherein the browsing ticket includes a plurality of indexes in order to specify the product information that is an object to be browsed by the browsing person, and the plurality of indexes include an index that serves to specify a revision of the product information that is the object to be browsed by the browsing person.

According to the present invention, it is possible to provide the information browsing system, the information browsing device, the information browsing method, and the computer-readable non-transitory storage medium storing a program therein, which can allow the browsing person to satisfactorily browse information concerning the product.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a block diagram showing an information browsing system according to a first embodiment;

FIG. 2 is a diagram conceptually showing an example of a browsing ticket:

FIG. 3 is a flow chart illustrating an example of operations of the information browsing system according to the first embodiment;

FIG. 4 is a flow chart illustrating an example of operations of the information browsing system according to the first embodiment;

FIG. 5 is a block diagram showing an information browsing system according to a second embodiment;

FIG. 6 is a diagram conceptually showing an example of a product information list;

FIG. 7 is a diagram conceptually showing an example of a browsing ticket;

FIG. 8 is a flow chart illustrating an example of operations of the information browsing system according to the second embodiment; and

FIG. 9 is a flow chart illustrating an example of operations of the information browsing system according to the second embodiment.

### DESCRIPTION OF THE INVENTION

### First Embodiment

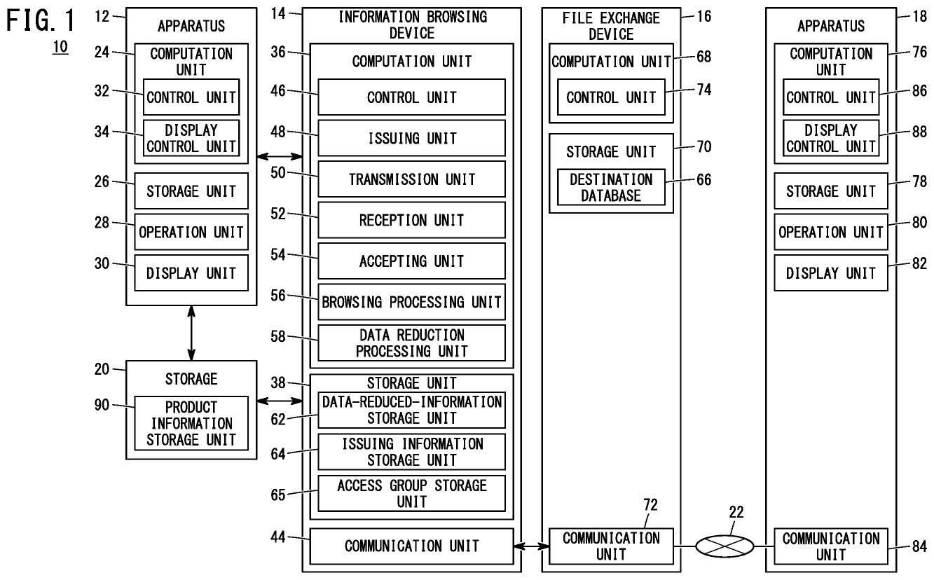

A description will be given with reference to FIGS. 1 to 4 concerning an information browsing system, an information browsing device, an information browsing method, and a computer-readable non-transitory storage medium having a program stored therein according to a first embodiment of the present invention. FIG. 1 is a block diagram showing an information browsing system according to the present embodiment.

The information browsing system 10 according to the present embodiment may be equipped with an apparatus 12, an information browsing device 14, a file exchange device 16, an apparatus 18, and a storage 20.

The apparatus 12 is provided, for example, in a certain office of a certain company. The user of the apparatus 12, for example, is an employee or the like who works at the office where the apparatus 12 is provided.

The apparatus 18 is provided, for example, at a client (business partner) of the company in which the apparatus 12 is provided. The user of the apparatus 18, for example, is an employee or the like who works for the business partner.

A first office from among a plurality of offices belonging to a certain company may be equipped with the apparatus 12, and a second office from among the plurality of such offices may be equipped with the apparatus 18.

The apparatus 12 may be located in a first country, and the apparatus 18 may be located in a second country that differs from the first country.

The apparatus 12 may be equipped with a computation unit 24, a storage unit 26, an operation unit 28, and a display unit 30. Moreover, it should be noted that, although the apparatus 12 may comprise constituent elements other than these constituent elements, descriptions of such other elements are omitted herein.

The computation unit 24 may be constituted by a processor such as a CPU (Central Processing Unit), a GPU (Graphics Processing Unit), or the like. More specifically, the computation unit 24 can be configured by a processing circuit (processing circuitry).

The computation unit 24 may be equipped with a control unit 32 and a display control unit 34. The control unit 32 and the display control unit 34 can be realized by programs stored in the storage unit 26 being executed by the computation unit 24. The control unit 32 administers the control of the apparatus 12 as a whole. The display control unit 34 is capable of controlling a screen display of the display unit 30. Moreover, it should be noted that, although the computation unit 24 may comprise constituent elements other than these constituent elements, descriptions of such other elements are omitted herein.

Moreover, it should be noted that at least a portion of the control unit 32 and the display control unit 34 may be implemented by an integrated circuit such as an ASIC (Application Specific Integrated Circuit) or a FPGA (Field-Programmable Gate Array). Further, at least a portion of the control unit 32 and the display control unit 34 may be constituted by an electronic circuit including a discrete device.

The storage unit 26 may include a non-illustrated volatile memory and a non-illustrated non-volatile memory. As the volatile memory, there may be cited, for example, a RAM (Random Access Memory). The volatile memory is used as a working memory of the processor, and temporarily stores data or the like required for processing or calculations. As the non-volatile memory, there may be cited, for example, a ROM (Read Only Memory), a flash memory, or the like. The non-volatile memory is used as a storage memory, and stores therein programs, tables, maps, and the like. At least a portion of the storage unit 26 may be provided in the processor, the integrated circuit, or the like, which were described above. Further, the storage unit 26 may further be equipped with an HDD (Hard Disk Drive), an SSD (Solid State Drive), or the like. Various applications (application programs) can be installed in the storage unit 26. For example, a CAD (Computer-Aided Design) application or the like can be installed in the storage unit 26.

The operation unit 28 can be used when the user performs an operation input with respect to the apparatus 12. As the operation unit 28, there may be cited a keyboard, a mouse, or the like, although the present invention is not limited to this feature. A non-illustrated display element may be provided in the display unit 30. As such a display element, there may be used, for example, a liquid crystal display element, an organic electroluminescence display element, or the like. The operation unit 28 and the display unit 30 may be constituted by a non-illustrated touch panel that is equipped with such a display element. The apparatus 12 is capable of communicating with the information browsing device 14 via a non-illustrated network or the like.

The information browsing device 14 may be equipped with a computation unit 36, a storage unit 38, and a communication unit 44. It should be noted that, although the information browsing device 14 may comprise constituent elements other than these constituent elements, descriptions of such other elements are omitted herein.

The computation unit 36 may be constituted by a processor such as a CPU, a GPU, or the like, and more specifically, processing circuitry. The computation unit 36 may be equipped with a control unit 46, an issuing unit 48, a transmission unit 50, a reception unit 52, an accepting unit 54, a browsing processing unit 56, and a data reduction processing unit 58. The control unit 46, the issuing unit 48, the transmission unit 50, the reception unit 52, the accepting unit 54, the browsing processing unit 56, and the data reduction processing unit 58 can be realized by programs stored in the storage unit 38 being executed by the computation unit 36. Moreover, it should be noted that, although the computation unit 36 may comprise constituent elements other than these constituent elements, descriptions of such other elements are omitted herein. Further, at least a portion of the control unit 46, the issuing unit 48, the transmission unit 50, the reception unit 52, the accepting unit 54, the browsing processing unit 56, and the data reduction processing unit 58 may be realized by an integrated circuit such as an ASIC, an FPGA, or the like. Further, at least a portion of the control unit 46, the issuing unit 48, the transmission unit 50, the reception unit 52, the accepting unit 54, the browsing processing unit 56, and the data reduction processing unit 58 may be constituted by an electronic circuit including a discrete device.

The storage unit 38 may include a non-illustrated volatile memory and a non-illustrated non-volatile memory. Further, the storage unit 38 may further be equipped with an HDD, an SSD, or the like. Further, a data-reduced-information storage unit 62, an issuing information storage unit 64, and an access group storage unit 65 are provided in the storage unit 38.

The communication unit 44 is equipped with, for example, a non-illustrated communication module. The communication unit 44 can carry out transmission and reception of data to and from a later-described communication unit 72 via a non-illustrated network or the like. Further, as noted previously, the information browsing device 14 is capable of communicating with the apparatus 12 via a non-illustrated network or the like.

The file exchange device 16, i.e., the file exchange system, may be equipped with a computation unit 68, a storage unit 70, and a communication unit 72. It should be noted that, although the file exchange device 16 may comprise constituent elements other than these constituent elements, descriptions of such other elements are omitted herein.

The computation unit 68 may be constituted by a processor such as a CPU, a GPU, or the like, and more specifically, processing circuitry. The computation unit 68 may be equipped with a control unit 74. The control unit 74 administers the control of the file exchange device 16 as a whole. Moreover, at least a portion of the control unit 74 may be realized by an integrated circuit such as an ASIC, an FPGA, or the like. Further, at least a portion of the control unit 74 may be constituted by an electronic circuit including a discrete device. Moreover, it should be noted that, although the computation unit 68 may comprise constituent elements other than these constituent elements, descriptions of such other elements are omitted herein.

The storage unit 70 may include a non-illustrated volatile memory and a non-illustrated non-volatile memory. Further, the storage unit 70 may further be equipped with an HDD, an SSD, or the like. Further, in the storage unit 70, there may be provided a destination database 66, or stated otherwise, a destination DB.

The communication unit 72 is equipped with, for example, a non-illustrated communication module. The communication unit 72 can carry out transmission and reception of data to and from the communication unit 44 via a non-illustrated network. Further, the communication unit 72 can carry out transmission and reception of data to and from a later-described communication unit 84 via a network 22 such as the Internet or the like.

The apparatus 18 may be equipped with a computation unit 76, a storage unit 78, an operation unit 80, a display unit 82, and a communication unit 84. It should be noted that, although the apparatus 18 may comprise constituent elements other than these constituent elements, descriptions of such other elements are omitted herein.

The computation unit 76 may be constituted by a processor such as a CPU, a GPU, or the like, and more specifically, processing circuitry. The computation unit 76 may be equipped with a control unit 86 and a display control unit 88. The control unit 86 and the display control unit 88 can be realized by programs stored in the storage unit 78 being executed by the computation unit 76. Moreover, it should be noted that, although the computation unit 76 may comprise constituent elements other than these constituent elements, descriptions of such other elements are omitted herein. The control unit 86 administers the control of the apparatus 18 as a whole. The display control unit 88 is capable of controlling a screen display of the display unit 82. Moreover, at least a portion of the control unit 86 and the display control unit 88 may be realized by an integrated circuit such as an ASIC, an FPGA, or the like. Further, at least a portion of the control unit 86 and the display control unit 88 may be constituted by an electronic circuit including a discrete device.

The storage unit 78 may include a non-illustrated volatile memory and a non-illustrated non-volatile memory. Further, the storage unit 78 may further be equipped with an HDD, an SSD, or the like.

The operation unit 80 can be used when the user performs an operation input with respect to the apparatus 18. As the operation unit 80, there may be cited a keyboard, a mouse, or the like, although the present invention is not limited to this feature. A non-illustrated display element may be provided in the display unit 82.

The communication unit 84 is equipped with, for example, a non-illustrated communication module. The communication unit 84 can carry out transmission and reception of data to and from the communication unit 72 via the network 22 such as the Internet or the like.

A product information storage unit 90 may be provided in the storage 20. The product information storage unit 90 stores product information (product data). The product information may be generated, for example, by a user who operates the apparatus 12. As the product information, there may be cited, for example, CAD data, CAE (Computer-Aided Engineering) data, and CG (Computer Graphics) data, although the present invention is not limited to this feature. For example, the product information may be any one from among these examples of data. Further, the product information may also be a combination from among these examples. As the CAD data, there may be cited, for example, two-dimensional CAD data and three-dimensional CAD data. The storage 20 can be accessed from both the apparatus 12 and the information browsing device 14. Moreover, the description provided herein is based on an exemplary case in which the storage 20 is provided separately from the apparatus 12, however, the storage 20 may be provided within the apparatus 12.

As noted previously, the information browsing device 14 may be equipped with the control unit 46. The control unit 46 administers the control of the information browsing device 14 as a whole.

As noted previously, the information browsing device 14 may be equipped with the data reduction processing unit 58. The data reduction processing unit 58 is capable of reducing data volume of the product information that is stored in the product information storage unit 90. Reducing data volume of the product information implies an action of making the data volume (data size) of the product information smaller. Reducing the data volume of the product information can be carried out by reducing the volume of data in relation to specified information included in the product information. For example, reduction of the data volume of the product information may be carried out by deleting or reducing the content not for browsing without deleting or reducing the content that is provided for browsing. The data volume of the product information can be made smaller, for example, by changing a data format of the product information. For example, in the case that 3D CAD data is converted into HPDF (Hybrid Portable Document Format) data with a conversion accuracy of 1/100 when the volume of such data is reduced, the size or volume of the data can be reduced, for example, to ⅕ to ⅛ of the original. It should be noted that reduction of the data volume of the product information is not limited to this feature. The data reduction processing unit 58 stores the data-reduced information obtained by reducing the data volume of the product information, in the data-reduced-information storage unit 62. The data reduction processing unit 58 periodically confirms the status of the product information storage unit 90. The data reduction processing unit 58 confirms whether or not the product information the data volume of which has not been reduced by the data reduction processing unit 58 exists in the product information storage unit 90. In the case that the product information the data volume of which has not been reduced by the data reduction processing unit 58 exists in the product information storage unit 90, then the data reduction processing unit 58 generates data-reduced information by reducing the data volume of the product information. The data reduction processing unit 58 stores the data-reduced information generated by the data reduction processing unit 58, in the data-reduced-information storage unit 62. The data size of the data-reduced information is smaller than the data size of the product information corresponding to the data-reduced information. The data size of the product information, for example, is on the order of 1 GB to 50 GB. In contrast thereto, in the case that the conversion accuracy at the time of reducing the data volume of information is 1/100, the data size obtained by reducing the data volume thereof reduces, for example, to ⅕ to ⅛ of the original. More specifically, the data size of the data-reduced information, for example, is on the order of 200 MB to 10 GB. In this manner, the data size of the data-reduced information is sufficiently smaller than the original data size of the product information. The data-reduced information is generated in a data format having a higher degree of versatility than that of the product information. Therefore, the browsing processing unit 56, which will be described later, is capable of allowing the browsing person to browse the data-reduced information without using the application software that was used when the product information was created.

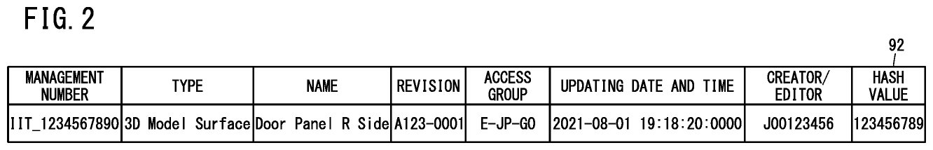

As noted previously, the information browsing device 14 may be equipped with the issuing unit 48. The issuing unit 48 issues a browsing ticket 92. More specifically, the issuing unit 48 issues a browsing ticket file. FIG. 2 is a diagram conceptually showing an example of the browsing ticket. An exemplary format for the browsing ticket 92 is shown in FIG. 2. The browsing ticket 92 is an electronic ticket used for allowing a specified browsing person to browse information concerning the product. As shown in FIG. 2, the browsing ticket 92 may include information indicating a management number of the browsing ticket 92. Further, the browsing ticket 92 may include information indicating a type of data of the product information that can be browsed using the browsing ticket 92. Further, the browsing ticket 92 may include information indicating a name of the product information that can be browsed using the browsing ticket 92. Further, the browsing ticket 92 may include information indicating a revision of the product information that can be browsed using the browsing ticket 92. Further, the browsing ticket 92 may include information concerning an access group. More specifically, the browsing ticket 92 may include information concerning an access group to which the browsing person belongs. The access group to which the browsing person belongs is determined in advance. The access group is assigned an authority corresponding to such an access group. As such an authority, there may be cited a reading authority which is an authority to read the product information, a rewriting authority which is an authority to rewrite the product information, and the like. The user of the apparatus 18 can access the product information within a scope of authority granted to the access group to which the user belongs. Moreover, the information indicating the authority granted to the access groups is stored in the access group storage unit 65. Further, the browsing ticket 92 may include information indicating an updating date and time of the product information that can be browsed using the browsing ticket 92. Further, the browsing ticket 92 may include information indicating a creator who has created the product information that can be browsed using the browsing ticket 92, or information indicating an editor who has edited the product information. Further, the browsing ticket 92 may include a hash value that is used when authenticating the concerned browsing ticket 92.

Issuance of the browsing ticket 92 can be carried out in a state in which communication is established between the apparatus 12 and the information browsing device 14. When the browsing ticket 92 is issued, a non-illustrated browsing ticket issuance screen used for issuing the browsing ticket 92 may be displayed on the display unit 30 of the apparatus 12. The user can select the product information that the user wants the browsing person to browse, on the browsing ticket issuance screen. The issuing unit 48 provided in the information browsing device 14 issues the browsing ticket 92 corresponding to the product information selected by the user. When the browsing ticket 92 is issued, the issuing unit 48 stores issuing information, which is information regarding issuance of the browsing ticket 92, in the issuing information storage unit 64. Information indicating the content of the browsing ticket 92 is included in the concerned issuing information. As for the information indicating the content of the browsing ticket 92, there may be cited, for example, the information described above with reference to FIG. 2, although the present invention is not limited to this feature.

As noted previously, the information browsing device 14 may be equipped with the transmission unit 50. The transmission unit 50 transmits the browsing ticket 92 issued by the issuing unit 48 to the browsing person. Transmission of the browsing ticket 92 can be carried out, for example, in a state in which communication is established between the apparatus 12, the information browsing device 14, and the file exchange device 16. Communication between the apparatus 12 and the file exchange device 16, for example, may be established via the information browsing device 14, although the present invention is not limited to this feature. When the browsing ticket 92 is transmitted, a non-illustrated browsing ticket transmission screen used for transmitting the browsing ticket 92 may be displayed on the display unit 30 of the apparatus 12. The user is capable of selecting a transmission destination (a transmission address, a destination) for the browsing ticket 92, on the browsing ticket transmission screen (destination selection screen). Moreover, the transmission destination for the browsing ticket 92 can be selected from among a plurality of destinations stored in the destination database 66 that is provided in the file exchange device 16, although the present invention is not limited to this feature. The transmission unit 50 transmits the browsing ticket 92 issued by the issuing unit 48 to a transmission destination selected by the user. In this instance, an exemplary case will be described in which the transmission destination for the browsing ticket 92 is the user who operates the apparatus 18. The transmission unit 50 transmits the browsing ticket 92 to the apparatus 18 via the file exchange device 16.

As noted previously, the information browsing device 14 may be equipped with the reception unit 52. The reception unit 52 receives the browsing ticket 92 which is presented from the browsing person. Presentation of the browsing ticket 92 may be performed via the file exchange device 16. Presentation of the browsing ticket 92 may be performed by uploading the browsing ticket 92 on a check-in screen, which will be described later. More specifically, presentation of the browsing ticket 92 may be performed by uploading a browsing ticket file on the check-in screen. The reception unit 52 receives the browsing ticket 92 which is presented from the apparatus 18 via the file exchange device 16.

As noted previously, the information browsing device 14 may be equipped with the accepting unit 54. The accepting unit 54 can perform an acceptance process to accept the browsing ticket 92 which is presented from the browsing person. More specifically, the accepting unit 54 can carry out the acceptance process to accept the browsing ticket 92 based on the issuing information that is stored in the issuing information storage unit 64. In the acceptance process to accept the browsing ticket 92, for example, a hash value appended to the browsing ticket 92 may be used to authenticate the browsing ticket 92, although the present invention is not limited to this feature.

As noted previously, the information browsing device 14 may be equipped with the browsing processing unit 56. In the case that the acceptance process to accept the browsing ticket 92 has been completed by the accepting unit 54, the browsing processing unit 56 allows the browsing person to browse the data-reduced information corresponding to the product information specified by the browsing ticket 92. The browsing ticket 92 includes information for specifying a revision of the product information that serves as an object to be browsed. Accordingly, it is possible to browse data-reduced information corresponding to the revision of the product information specified by the browsing ticket 92. Browsing of the data-reduced information can be performed in a state in which communication is established between the information browsing device 14, the file exchange device 16, and the apparatus 18. The data-reduced information can be displayed on the display unit 82 provided in the apparatus 18. The data-reduced information is not downloaded to the apparatus 18. A signal for displaying the data-reduced information on the display unit 82 provided in the apparatus 18 is supplied from the information browsing device 14 to the apparatus 18 via the file exchange device 16. A browsing person can browse the data-reduced information that is displayed on the display unit 82 provided in the apparatus 18. In the manner described above, the data-reduced information is generated in a data format having a higher degree of versatility than that of the product information. Therefore, the browsing processing unit 56 is capable of allowing the browsing person to browse the data-reduced information without using the application software that was used when the product information was created. Further, browsing of the data-reduced information can be performed in a state in which communication is established between the information browsing device 14 and the apparatus 12. The data-reduced information can be displayed on the display unit 30 provided in the apparatus 12. The data-reduced information is not downloaded to the apparatus 12. A signal for displaying the data-reduced information on the display unit 30 provided in the apparatus 12 is supplied from the information browsing device 14 to the apparatus 12. The user who operates the apparatus 12 can browse the data-reduced information that is displayed on the display unit 30 provided in the apparatus 12. The user who operates the apparatus 12 and the browsing person who operates the apparatus 18 can browse the data-reduced information that is displayed in this manner, on the respective apparatuses. In this manner, the product information can be shared between the user who operates the apparatus 12 and the browsing person who operates the apparatus 18.

Further, as noted previously, the data size of the data-reduced information is sufficiently small. Therefore, in accordance with the present embodiment, it is possible for the browsing person to quickly browse the information concerning the product. In addition, the data-reduced information is generated in a data format having a high degree of versatility. Therefore, the browsing processing unit 56 is capable of allowing the browsing person to browse the data-reduced information without using the application software that was used when the product information was created.

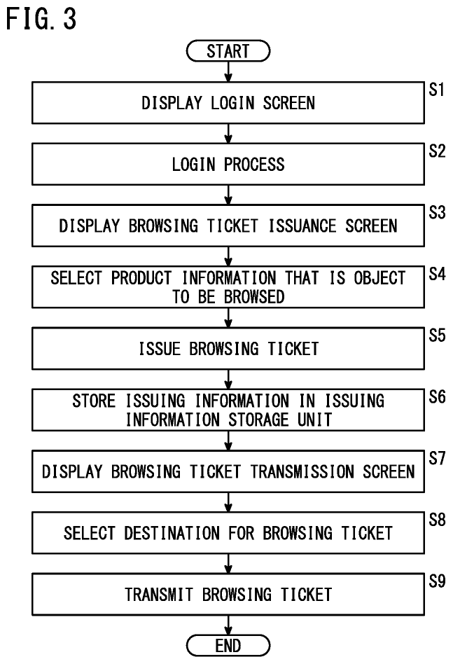

Next, a description will be given concerning operations of the information browsing system according to the present embodiment. FIG. 3 is a flow chart illustrating an example of operations of the information browsing system according to the present embodiment.

In step S1, a non-illustrated login screen is displayed on the display unit 30 of the apparatus 12. Such a login screen is a screen in order for the apparatus 12 to login to the file exchange device 16. In a state in which communication is established between the apparatus 12, the information browsing device 14, and the file exchange device 16, the login screen is displayed on the display unit 30 of the apparatus 12. Thereafter, the process transitions to step S2.

In step S2, logging in is carried out by the user who operates the apparatus 12. Such logging in is performed on the login screen that is displayed on the display unit 30 of the apparatus 12. Thereafter, the process transitions to step S3.

In step S3, a non-illustrated browsing ticket issuance screen is displayed on the display unit 30 of the apparatus 12. A product information list including a plurality of items of the product information can be displayed on the browsing ticket issuance screen. Thereafter, the process transitions to step S4.

In step S4, the product information that serves as an object to be browsed by the browsing person is selected. Selection of the product information can be performed, for example, on the browsing ticket issuance screen that is displayed on the display unit 30 of the apparatus 12. Selection of the product information may be carried out by the user who operates the apparatus 12. Thereafter, the process transitions to step S5.

In step S5, the issuing unit 48 issues the browsing ticket 92 corresponding to the product information selected by the user. Thereafter, the process transitions to step S6.

In step S6, the issuing unit 48 stores in the issuing information storage unit 64 the information concerning the browsing ticket 92 issued by the issuing unit 48. More specifically, the issuing unit 48 stores in the issuing information storage unit 64 the issuing information, which is information regarding issuance of the browsing ticket 92. Thereafter, the process transitions to step S7.

In step S7, a non-illustrated browsing ticket transmission screen is displayed on the display unit 30 of the apparatus 12. Thereafter, the process transitions to step S8.

In step S8, the transmission destination for the browsing ticket 92 is selected. Selection of the transmission destination for the browsing ticket 92 can be carried out, for example, on the browsing ticket transmission screen that is displayed on the display unit 30 of the apparatus 12. Selection of the transmission destination for the browsing ticket 92 can be carried out by the user who operates the apparatus 12. Moreover, the transmission destination for the browsing ticket 92 can be selected from among a plurality of destinations stored in the destination database 66 that is provided in the file exchange device 16, although the present invention is not limited to this feature. Thereafter, the process transitions to step S9.

In step S9, the transmission unit 50 transmits the browsing ticket 92 issued by the issuing unit 48 to the transmission destination selected by the user. In this instance, an exemplary case will be described in which the transmission destination for the browsing ticket 92 is the user who operates the apparatus 18. The transmission unit 50 transmits the browsing ticket 92 to the apparatus 18 via the file exchange device 16. In this manner, the process shown in FIG. 3 is brought to an end.

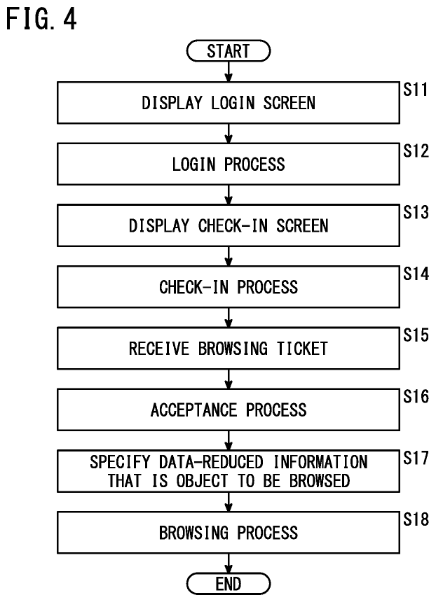

FIG. 4 is a flow chart illustrating an example of operations of the information browsing system according to the present embodiment.

In step S11, a non-illustrated login screen is displayed on the display unit 82 of the apparatus 18. Such a login screen is a screen provided in order for the apparatus 18 to login to the file exchange device 16. In a state in which communication is established between the apparatus 18 and the file exchange device 16, the login screen is displayed on the display unit 82 that is provided in the apparatus 18. Thereafter, the process transitions to step S12.

In step S12, logging in is carried out by the user who operates the apparatus 18. Such logging in is performed on the login screen that is displayed on the display unit 82 of the apparatus 18. Thereafter, the process transitions to step S13.

In step S13, a non-illustrated check-in screen is displayed on the display unit 82 of the apparatus 18. The check-in screen is a screen provided in order to perform checking in of the browsing ticket 92. More specifically, the check-in screen is a screen provided in order for the browsing person to present the browsing ticket 92. Thereafter, the process transitions to step S14.

In step S14, checking in is carried out by the user who operates the apparatus 18. More specifically, the browsing ticket 92 is presented by the user. Presentation of the browsing ticket 92 may be performed by uploading the browsing ticket 92 on the check-in screen. More specifically, presentation of the browsing ticket 92 may be performed by uploading a browsing ticket file on the check-in screen. Presentation of the browsing ticket 92 may be performed via the file exchange device 16. Thereafter, the process transitions to step S15.

In step S15, the reception unit 52 receives the browsing ticket 92 that is presented from the browsing person. The reception unit 52 receives the browsing ticket 92 which is presented from the apparatus 18 via the file exchange device 16. Thereafter, the process transitions to step S16.

In step S16, the accepting unit 54 performs an acceptance process to accept the browsing ticket 92 which is presented from the browsing person. More specifically, the accepting unit 54 can carry out the acceptance process to accept the browsing ticket 92 based on the issuing information that is stored in the issuing information storage unit 64. In the acceptance process to accept the browsing ticket 92, for example, a hash value appended to the browsing ticket 92 may be used to authenticate the browsing ticket 92. Specifically, authentication of the browsing ticket 92 can be carried out by confirming whether or not the hash value in the browsing ticket 92 presented from the browsing person coincides with the hash value in the issuing information that is stored in the issuing information storage unit 64. Thereafter, the process transitions to step S17.

In step S17, the browsing processing unit 56 specifies the data-reduced information corresponding to the product information specified by the browsing ticket 92. More specifically, the browsing processing unit 56 specifies the data-reduced information that serves as an object to be browsed. Thereafter, the process transitions to step S18.

In step S18, the browsing processing unit 56 allows the browsing person to browse the data-reduced information that is specified as the object to be browsed. Browsing of the data-reduced information can be performed in a state in which communication is established between the information browsing device 14, the file exchange device 16, and the apparatus 18. The data-reduced information can be displayed on the display unit 82 provided in the apparatus 18. The browsing person can browse the data-reduced information that is displayed on the display unit 82 provided in the apparatus 18. Further, browsing of the data-reduced information can be performed in a state in which communication is established between the information browsing device 14 and the apparatus 12. The data-reduced information can be displayed on the display unit 30 provided in the apparatus 12. The user who operates the apparatus 12 can browse the data-reduced information that is displayed on the display unit 30 provided in the apparatus 12. The user who operates the apparatus 12 and the browsing person who operates the apparatus 18 can browse the data-reduced information that is displayed in this manner, on the respective apparatuses. In this manner, the product information can be shared between the user who operates the apparatus 12 and the browsing person who operates the apparatus 18. In this manner, the process shown in FIG. 4 is brought to an end.

In the foregoing manner, according to the present embodiment, in the case that the browsing ticket 92 is accepted by the accepting unit 54, the browsing person is allowed to browse the data-reduced information corresponding to the product information specified by the browsing ticket 92. The data size of the data-reduced information is sufficiently small. Therefore, in accordance with the present embodiment, it is possible for the browsing person to quickly browse the information concerning the product. In addition, the data-reduced information is generated in a data format having a high degree of versatility. Therefore, according to the present embodiment, the browsing person can browse the data-reduced information without using the application software that was used when the product information was created. Therefore, in accordance with the present embodiment, it is possible for the browsing person to satisfactorily browse the information concerning the product.

### Second Embodiment

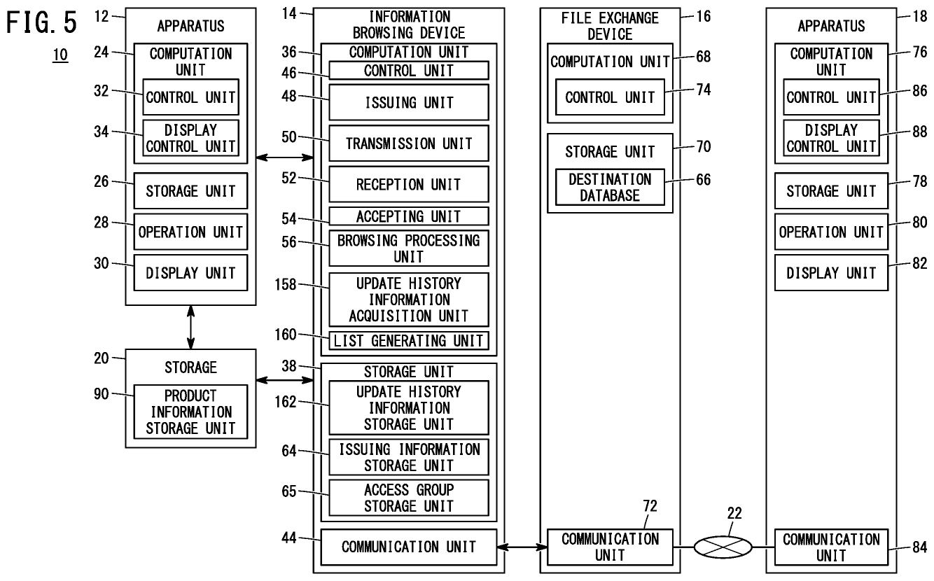

A description will be given with reference to FIGS. 5 to 9 concerning an information browsing system, an information browsing device, an information browsing method, and a program according to a second embodiment. FIG. 5 is a block diagram showing the information browsing system according to the present embodiment. The same constituent elements as those of the information browsing system according to the first embodiment shown in FIGS. 1 to 4 are denoted by the same reference numerals, and descriptions of such elements will be omitted or presented in a simplified manner.

According to the present embodiment, the computation unit 36 that is provided in the information browsing device 14 may be equipped with an update history information acquisition unit 158, and a list generating unit 160. Further, in the same manner as the information browsing device 14 described above with reference to FIG. 1, the control unit 46, the issuing unit 48, the transmission unit 50, the reception unit 52, the accepting unit 54, and the browsing processing unit 56 may be provided in the computation unit 36. The update history information acquisition unit 158 and the list generating unit 160 can be realized by programs stored in the storage unit 38 being executed by the computation unit 36. Moreover, it should be noted that, although the computation unit 36 may comprise constituent elements other than these constituent elements, descriptions of such other elements are omitted herein. Moreover, at least a portion of the update history information acquisition unit 158 and the list generating unit 160 may be realized by an integrated circuit such as an ASIC, an FPGA, or the like. Further, at least a portion of the update history information acquisition unit 158 and the list generating unit 160 may be constituted by an electronic circuit including a discrete device.

According to the present embodiment, the storage unit 38 that is provided in the information browsing device 14 may be equipped with an update history information storage unit 162. Further, in the same manner as the information browsing device 14 described above with reference to FIG. 1, the issuing information storage unit 64, and the access group storage unit 65 may be provided in the storage unit 38.

The product information storage unit 90 may be provided in the storage 20, in the same manner as the storage 20 described above with reference to FIG. 1. The product information storage unit 90 stores product information (product data). The product information may be generated, for example, by a user who operates the apparatus 12. As the product information, there may be cited, for example, CAD data, CAE data, moving image data, TIFF (Tagged Image File Format) data, CG data, authentication data, or ECU (Electronic Control Unit) data, although the present invention is not limited to this feature. For example, the product information may be any one from among these examples of data. Further, the product information may also be a combination from among these examples. As the CAD data, there may be cited, for example, two-dimensional CAD data and three-dimensional CAD data. The storage 20 can be accessed from both the apparatus 12 and the information browsing device 14. Moreover, the description provided herein is based on an exemplary case in which the storage 20 is provided separately from the apparatus 12, however, the storage 20 may be provided within the apparatus 12. Information indicating a history of updating of the product information may be provided in the product information. The information indicating the history of updating of the product information may be updated each time that a revision is performed with respect to the product information. Since information indicating the history of updating of the product information is provided in the product information, the product information can be appropriately rolled back to previous revisions of the product information. More specifically, a plurality of items of the product information having revisions that differ from one another exist in the product information in which the revisions thereof were carried out.

As noted previously, the information browsing device 14 may be equipped with the update history information acquisition unit 158. The update history information acquisition unit 158 can acquire update history information, which is information concerning the update history of the product information that is stored in the product information storage unit 90. The update history information acquisition unit 158 stores the acquired update history information in the update history information storage unit 162. The update history information acquisition unit 158 periodically confirms the status of the product information storage unit 90. Based on the product information that is stored in the product information storage unit 90, the update history information acquisition unit 158 confirms whether or not updating of the product information has been newly carried out. In the case that product information which has been newly updated exists in the product information storage unit 90, the update history information acquisition unit 158 updates the update history information that is stored in the update history information storage unit 162.

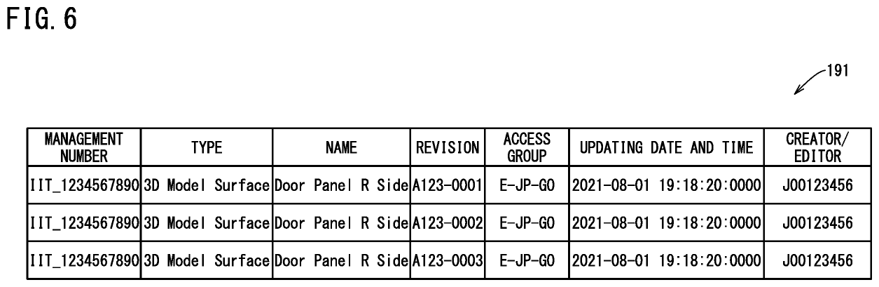

As noted previously, the information browsing device 14 may be equipped with the list generating unit 160. Based on the update history information, the list generating unit 160 generates a product information list 191 including a list of a plurality of items of the product information having revisions that differ from one another. FIG. 6 is a diagram showing an example of the product information list. An exemplary format for the product information list 191 is shown in FIG. 6. As shown in FIG. 6, information indicating a management number of the product information may be included in the product information list 191. Further, information indicating a type of data of the product information may be included in the product information list 191. Further, information indicating a name of the product information may be included in the product information list 191. Further, information indicating a revision of the product information may be included in the product information list 191. Information concerning an access group may be included in the product information list 191. More specifically, information concerning an access group to which the browsing person belongs may be included in a browsing ticket 192. The access group to which the browsing person belongs is determined in advance. The access group is assigned an authority corresponding to such an access group. As such an authority, there may be cited a reading authority which is an authority to read the product information, a rewriting authority which is an authority to rewrite the product information, and the like. The user of the apparatus 18 can access the product information within a scope of authority granted to the access group to which the user belongs. Moreover, the information indicating the authority granted to the access groups is stored in the access group storage unit 65. Further, information indicating an updating date and time of the product information may be included in the product information list 191. Further, information concerning the creator who created the product information or information indicating the editor who edited the product information may be included in the product information list 191.

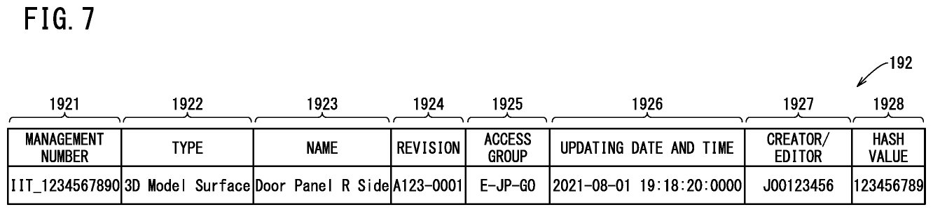

As noted previously, the information browsing device 14 may be equipped with the issuing unit 48. The issuing unit 48 issues the browsing ticket 192. More specifically, the issuing unit 48 issues a browsing ticket file. FIG. 7 is a diagram showing an example of the browsing ticket. An exemplary format for the browsing ticket 192 is shown in FIG. 7. The browsing ticket 192 is an electronic ticket used for allowing a specified browsing person to browse information concerning the product. The browsing ticket 192 includes a plurality of indexes 1921 to 1928 in order to specify the product information that serves as an object to be browsed by the browsing person. Information indicating the management number of the concerned browsing ticket 192 is shown in the index 1921. Information indicating a type of data of the product information that can be browsed using the browsing ticket 192 is shown in the index 1922. Further, information indicating a name of the product information that can be browsed using the browsing ticket 192 is shown in the index 1923. Further, information indicating a revision of the product information that can be browsed using the browsing ticket 192 may be included in the index 1924. More specifically, the index 1924 is an index for specifying a revision of the product information that serves as the object to be browsed by the browsing person. Information concerning the access groups is shown in the index 1925. Further, information indicating an updating date and time of the product information that can be browsed using the browsing ticket 192 is shown in the index 1926. Information indicating a creator who has created the product information that can be browsed using the browsing ticket 192, or information indicating an editor who has edited the product information is shown in the index 1927. A hash value that is used when authenticating the concerned browsing ticket 192 is shown in the index 1928.

Issuance of the browsing ticket 192 can be carried out in a state in which communication is established between the apparatus 12 and the information browsing device 14. When the browsing ticket 192 is issued, a non-illustrated browsing ticket issuance screen used for issuing the browsing ticket 192 may be displayed on the display unit 30 of the apparatus 12. The product information list 191 generated by the list generating unit 160 can be displayed on the browsing ticket issuance screen. The user can select the product information that the user wants the browsing person to browse, on the browsing ticket issuance screen. In the case that a plurality of items of the product information having revisions that differ from one another exist, the product information list 191 including the plurality of items of the product information having revisions that differ from one another can be displayed on the browsing ticket issuance screen. From among the plurality of items of the product information having revisions that differ from one another, the user is capable of selecting the product information that the user wants the browsing person to browse. The issuing unit 48 provided in the information browsing device 14 issues the browsing ticket 192 for allowing the browsing person to browse the product information that is selected from within the product information list 191. When the browsing ticket 192 is issued, the issuing unit 48 stores issuing information, which is information regarding issuance of the browsing ticket 192, in the issuing information storage unit 64. Information indicating the content of the browsing ticket 192 is included in the concerned issuing information. As for the information indicating the content of the browsing ticket 192, there may be cited, for example, the information described above with reference to FIG. 7, although the present invention is not limited to this feature.

As noted previously, the information browsing device 14 may be equipped with the browsing processing unit 56. In the case that the acceptance process to accept the browsing ticket 192 has been completed by the accepting unit 54, the browsing processing unit 56 specifies the product information serving as the object to be browsed, based on the browsing ticket 192. As noted previously, information for specifying a revision of the product information that serves as the object to be browsed is included in the browsing ticket 192. Therefore, even in the case that a plurality of items of the product information having revisions that differ from one another exist, the product information having a revision, which serves as the object to be browsed, can be reliably specified based on the browsing ticket 192. The browsing processing unit 56 allows the product information that is specified by such a browsing ticket 192 to be browsed by the browsing person. Browsing of the product information can be performed in a state in which communication is established between the information browsing device 14, the file exchange device 16, and the apparatus 18. The product information can be displayed on the display unit 82 provided in the apparatus 18. The product information is not downloaded to the apparatus 18. A signal for displaying the product information on the display unit 82 provided in the apparatus 18 is supplied from the information browsing device 14 to the apparatus 18 via the file exchange device 16. The browsing person can browse the product information that is displayed on the display unit 82 provided in the apparatus 18. Further, browsing of the product information can be performed in a state in which communication is established between the information browsing device 14 and the apparatus 12. The product information can be displayed on the display unit 30 provided in the apparatus 12. The product information is not downloaded to the apparatus 12. A signal for displaying the product information on the display unit 30 provided in the apparatus 12 is supplied from the information browsing device 14 to the apparatus 12. The user who operates the apparatus 12 can browse the product information that is displayed on the display unit 30 provided in the apparatus 12. The product information that is displayed in this manner can be browsed by the user who operates the apparatus 12, and the browsing person who operates the apparatus 18. In this manner, the product information can be shared between the user who operates the apparatus 12 and the browsing person who operates the apparatus 18.

The process to reduce data volume may also be implemented on the product information. That is, the product information may be data-reduced information. The data size of the data-reduced information is sufficiently small. Therefore, if the data-reduced information is used, it is possible for the browsing person to quickly browse the information concerning the product. Further, the data-reduced information is generated in a data format having a high degree of versatility. Therefore, use of data-reduced information can allow the browsing person to browse the data-reduced information without using the application software that was used when the product information was created.

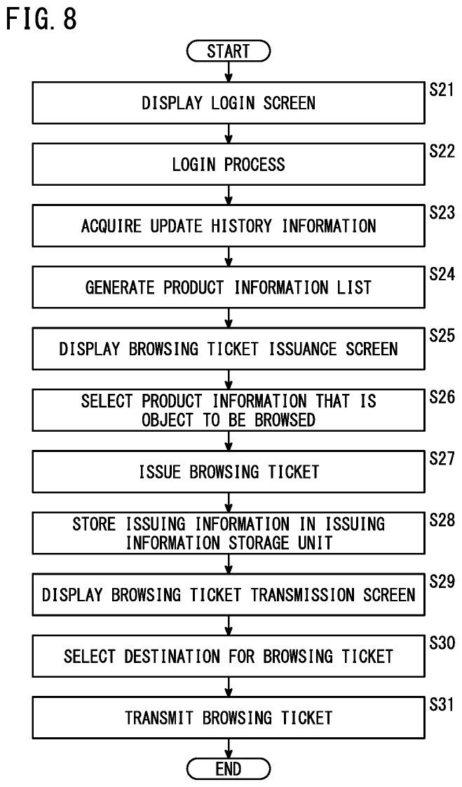

Next, a description will be given concerning operations of the information browsing system according to the present embodiment. FIG. 8 is a flow chart illustrating an example of operations of the information browsing system according to the present embodiment.

In step S21, a non-illustrated login screen is displayed on the display unit 30 of the apparatus 12. Such a login screen is a screen used in order for the apparatus 12 to login to the file exchange device 16. In a state in which communication is established between the apparatus 12, the information browsing device 14, and the file exchange device 16, the login screen is displayed on the display unit 30 of the apparatus 12. Thereafter, the process transitions to step S22.

In step S22, logging in is carried out by the user who operates the apparatus 12. Such logging in is performed on the login screen that is displayed on the display unit 30 of the apparatus 12. Thereafter, the process transitions to step S23.

In step S23, the list generating unit 160 acquires the update history information that was acquired in advance by the update history information acquisition unit 158. Thereafter, the process transitions to step S24.

In step S24, the list generating unit 160 generates the product information list 191 on the basis of the update history information. Thereafter, the process transitions to step S25.

In step S25, a non-illustrated browsing ticket issuance screen is displayed on the display unit 30 of the apparatus 12. The product information list 191 including a plurality of items of the product information in which revisions thereof differ from each other can be displayed on the browsing ticket issuance screen. Thereafter, the process transitions to step

In step S26, the product information that serves as an object to be browsed by the browsing person is selected. Selection of the product information can be performed, for example, on the browsing ticket issuance screen that is displayed on the display unit 30 of the apparatus 12. Selection of the product information may be carried out by the user who operates the apparatus 12. Thereafter, the process transitions to step S27.

In step S27, the issuing unit 48 issues the browsing ticket 192 corresponding to the product information selected by the user. Thereafter, the process transitions to step S28.

In step S28, the issuing unit 48 stores in the issuing information storage unit 64 the information concerning the browsing ticket 192 issued by the issuing unit 48. More specifically, the issuing unit 48 stores in the issuing information storage unit 64 the issuing information, which is information regarding issuance of the browsing ticket 192. Thereafter, the process transitions to step S29.

In step S29, a non-illustrated browsing ticket transmission screen is displayed on the display unit 30 of the apparatus 12. Thereafter, the process transitions to step S30.

In step S30, the transmission destination for the browsing ticket 192 is selected. Selection of the transmission destination for the browsing ticket 192 can be carried out, for example, on the browsing ticket transmission screen that is displayed on the display unit 30 of the apparatus 12. Selection of the transmission destination for the browsing ticket 192 can be carried out by the user who operates the apparatus 12. Moreover, the transmission destination for the browsing ticket 192 can be selected from among a plurality of destinations stored in the destination database 66 that is provided in the file exchange device 16, although the present invention is not limited to this feature. Thereafter, the process transitions to step S31.

In step S31, the transmission unit 50 transmits the browsing ticket 192 issued by the issuing unit 48 to the transmission destination selected by the user. In this instance, an exemplary case will be described in which the transmission destination for the browsing ticket 192 is the user who operates the apparatus 18. The transmission unit 50 transmits the browsing ticket 192 to the apparatus 18 via the file exchange device 16. In this manner, the process shown in FIG. 8 is brought to an end.

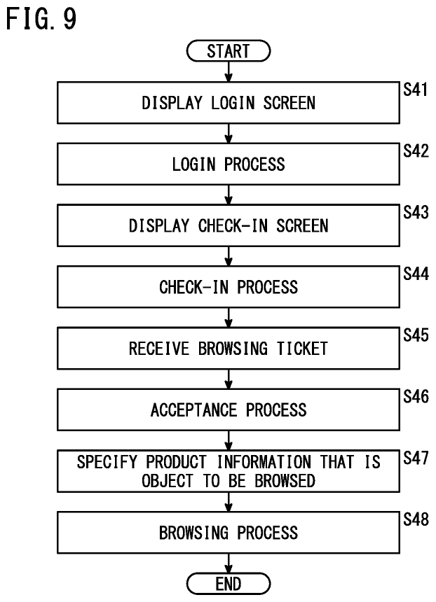

FIG. 9 is a flow chart illustrating an example of operations of the information browsing system according to the present embodiment.

In step S41, a non-illustrated login screen is displayed on the display unit 82 of the apparatus 18. Such a login screen is a screen used in order for the apparatus 18 to login to the file exchange device 16. In a state in which communication is established between the apparatus 18 and the file exchange device 16, the login screen is displayed on the display unit 82 that is provided in the apparatus 18. Thereafter, the process transitions to step S42.

In step S42, logging in is carried out by the user who operates the apparatus 18. Such logging in is performed on the login screen that is displayed on the display unit 82 of the apparatus 18. Thereafter, the process transitions to step S43.

In step S43, a non-illustrated check-in screen is displayed on the display unit 82 of the apparatus 18. The check-in screen is provided in order to perform checking in of the browsing ticket 192. More specifically, the check-in screen is provided in order for the browsing person to present the browsing ticket 192. Thereafter, the process transitions to step S44.

In step S44, checking in is performed by the user who operates the apparatus 18. More specifically, the browsing ticket 192 is presented by the user. Presentation of the browsing ticket 192 may be performed by uploading the browsing ticket 192 on the check-in screen. More specifically, presentation of the browsing ticket 192 may be performed by uploading a browsing ticket file on the check-in screen. Presentation of the browsing ticket 192 may be performed via the file exchange device 16. Thereafter, the process transitions to step S45.

In step S45, the reception unit 52 receives the browsing ticket 192 that is presented from the browsing person. The reception unit 52 receives the browsing ticket 192 which is presented from the apparatus 18 via the file exchange device 16. Thereafter, the process transitions to step S46.

In step S46, the accepting unit 54 carries out the acceptance process to accept the browsing ticket 192 which is presented from the browsing person. More specifically, the accepting unit 54 can carry out the acceptance process to accept the browsing ticket 192 based on the issuing information that is stored in the issuing information storage unit 64. In the acceptance process to accept the browsing ticket 192, for example, a hash value appended to the browsing ticket 192 may be used to authenticate the browsing ticket 192. Specifically, authentication of the browsing ticket 192 can be carried out by confirming whether or not the hash value in the browsing ticket 192 presented from the browsing person coincides with the hash value in the issuing information that is stored in the issuing information storage unit 64. Thereafter, the process transitions to step S47.

In step S47, the browsing processing unit 56 identifies the product information that serves as the object to be browsed, based on the browsing ticket 192. Thereafter, the process transitions to step S48.

In step S48, the browsing processing unit 56 allows the browsing person to browse the specified product information. Browsing of the product information can be performed in a state in which communication is established between the information browsing device 14, the file exchange device 16, and the apparatus 18. The product information can be displayed on the display unit 82 provided in the apparatus 18. The browsing person can browse the product information that is displayed on the display unit 82 provided in the apparatus 18. Further, browsing of the product information can be performed in a state in which communication is established between the information browsing device 14 and the apparatus 12. The product information can be displayed on the display unit 30 provided in the apparatus 12. The user who operates the apparatus 12 can browse the product information that is displayed on the display unit 30 provided in the apparatus 12. The product information that is displayed in this manner can be browsed by the user who operates the apparatus 12, and the browsing person who operates the apparatus 18. In this manner, the product information can be shared between the user who operates the apparatus 12 and the browsing person who operates the apparatus 18. In this manner, the process shown in FIG. 9 is brought to an end.

In the foregoing manner, according to the present embodiment, the index 1924 in order to specify the revision of the product information that serves as the object to be browsed by the browsing person is provided in the browsing ticket 192. For this reason, according to the present embodiment, even in the case that a plurality of items of the product information having revisions that differ from one another exist, it is possible to reliably specify the product information that serves as the object to be browsed. Therefore, in accordance with the present embodiment, it is possible for the browsing person to satisfactorily browse the information concerning the product.

Moreover, it should be noted that the present invention is not limited to the embodiments described above, and various configurations can be adopted therein without departing from the essence and gist of the present invention.

For example, the first embodiment and the second embodiment may be appropriately combined within a range in which no technical inconsistencies occur.

The inventions that can be grasped from the above-described embodiments will be described below.

The information browsing system (10) is equipped with the data-reduced-information storage unit (62) that stores the data-reduced information obtained by reducing the data volume of the product information, the accepting unit (54) that accepts the presentation of the browsing ticket (92) from the browsing person, and the browsing processing unit (56) which, in the case that the browsing ticket has been accepted by the accepting unit, allows the browsing person to browse the data-reduced information corresponding to the product information specified by the browsing ticket. In accordance with such a configuration, in the case that the browsing ticket is accepted by the accepting unit, the browsing person is allowed to browse the data-reduced information corresponding to the product information specified by the browsing ticket. The data size of the data-reduced information is sufficiently small. Therefore, in accordance with the present embodiment, it is possible for the browsing person to quickly browse the information concerning the product. In addition, the data-reduced information is generated in a data format having a high degree of versatility. Therefore, in accordance with such a configuration, the browsing person can browse the data-reduced information without using the application software that was used when the product information was created. In the foregoing manner, in accordance with such a configuration, it is possible for the browsing person to browse the information concerning the product in a satisfactory manner.

There may further be provided the issuing unit (48) that issues the browsing ticket, and the issuing information storage unit (64) that stores the issuing information, which is information regarding issuance of the browsing ticket, wherein the accepting unit accepts the browsing ticket based on the issuing information that is stored in the issuing information storage unit.

There may further be provided the data reduction processing unit (58), which generates the data-reduced information by reducing the data volume of the product information that is stored in the product information storage unit (90), and stores the generated data-reduced information in the data-reduced-information storage unit.

There may further be provided the transmission unit (50) that transmits the browsing ticket to the browsing person designated by the user.

The product information may be at least one of CAD (Computer-Aided Design) data, CAE (Computer-Aided Engineering) data, or CG (Computer Graphics) data.

The information browsing system (10) is equipped with the issuing unit (48) that issues the browsing ticket (192) that serves to allow the browsing person to browse the product information, and the transmission unit (50) that transmits the browsing ticket issued by the issuing unit to the browsing person, wherein the browsing ticket includes the plurality of indexes (1921 to 1928) in order to specify the product information that is the object to be browsed by the browsing person, and the plurality of indexes include the index (1924) that serves to specify a revision of the product information that is the object to be browsed by the browsing person. In accordance with such a configuration, the index that serves to specify the revision of the product information that is the object to be browsed by the browsing person is provided in the browsing ticket. For this reason, in accordance with such a configuration, even in the case that a plurality of items of the product information having revisions that differ from one another exist, it is possible to reliably specify the product information that serves as the object to be browsed. Therefore, in accordance with such a configuration, it is possible for the browsing person to browse the information concerning the product in a satisfactory manner.

In the above-described information browsing system, there may further be provided the update history information acquisition unit (158) that acquires the update history information, which is information concerning an update history of the product information, and the list generating unit (60) that generates, based on the update history information, the product information list (191) including the list of the plurality of items of the product information the revisions of which differ from one another, wherein the issuing unit issues the browsing ticket that serves to allow the browsing person to browse the product information selected from the product information list.

In the above-described information browsing system, there may further be provided the issuing information storage unit (64) that stores the issuing information, which is information concerning the issuance of the browsing ticket, the accepting unit (54) that accepts the browsing ticket presented from the browsing person, based on the issuing information that is stored in the issuing information storage unit, and the browsing processing unit (56) which, in the case that the browsing ticket has been accepted by the accepting unit, allows the browsing person to browse the product information specified by the browsing ticket.

In the above-described information browsing system, the product information may be at least one of CAD (Computer-Aided Design) data, CAE (Computer-Aided Engineering) data, moving image data, TIFF (Tagged Image File Format) data, CG (Computer Graphics) data, authentication data, and ECU (Electronic Control Unit) data.

The information browsing device (14) includes the accepting unit that accepts the presentation of the browsing ticket from the browsing person, and the browsing processing unit which, in the case that the browsing ticket has been accepted by the accepting unit, allows the browsing person to browse the data-reduced information corresponding to the product information specified by the browsing ticket, the data-reduced information being obtained by reducing the data volume of the product information.

There may further be provided the issuing unit that issues the browsing ticket, and the issuing information storage unit that stores the issuing information, which is information regarding issuance of the browsing ticket, wherein the accepting unit accepts the browsing ticket based on the issuing information that is stored in the issuing information storage unit.

The information browsing device (14) includes the issuing unit that issues the browsing ticket that serves to allow the browsing person to browse the product information, wherein the browsing ticket includes the plurality of indexes in order to specify the product information that is the object to be browsed by the browsing person, and the plurality of indexes include the index that serves to specify a revision of the product information that is the object to be browsed by the browsing person.

In the above-described information browsing device, there may further be provided the update history information acquisition unit that acquires the update history information, which is information concerning an update history of the product information, and the list generating unit that generates, based on the update history information, the product information list including the list of the plurality of items of the product information the revisions of which differ from one another, wherein the issuing unit issues the browsing ticket that serves to allow the browsing person to browse the product information selected from the product information list.

In the above-described information browsing device, there may further be provided the issuing information storage unit that stores the issuing information, which is information concerning the issuance of the browsing ticket, the accepting unit that accepts the browsing ticket presented from the browsing person, based on the issuing information that is stored in the issuing information storage unit, and the browsing processing unit which, in the case that the browsing ticket has been accepted by the accepting unit, allows the browsing person to browse the product information specified by the browsing ticket.

The information browsing method includes the step of accepting the presentation of the browsing ticket from the browsing person (step S16), and the step of, in the case that the browsing ticket has been accepted, allowing the browsing person to browse the data-reduced information corresponding to the product information specified by the browsing ticket, the data-reduced information being obtained by reducing the data volume of the product information (step S18).

There may further be provided the step of issuing the browsing ticket (step S5), and the step of storing the issuing information, which is information regarding issuance of the browsing ticket (step S6), wherein, in the step of accepting the presentation of the browsing ticket, the browsing ticket is accepted based on the issuing information.

The information browsing method includes the step of issuing the browsing ticket that serves to allow the browsing person to browse the product information (step S27), and the step of transmitting the issued browsing ticket to the browsing person (step S31), wherein the browsing ticket includes the plurality of indexes in order to specify the product information that is the object to be browsed by the browsing person, and the plurality of indexes include the index that serves to specify a revision of the product information that is the object to be browsed by the browsing person.

In the above-described information browsing method, there may further be provided the step of acquiring the update history information, which is information concerning an update history of the product information (step S23), and the step of generating, based on the update history information, the product information list including the list of the plurality of items of the product information the revisions of which differ from one another (step S24), wherein, in the step of issuing the browsing ticket, the browsing ticket that serves to allow the browsing person to browse the product information selected from the product information list is issued.

In the computer-readable non-transitory storage medium storing a program, the program causes the computer to execute a process including: accepting the presentation of the browsing ticket from the browsing person; and allowing the browsing person to browse the data-reduced information corresponding to the product information specified by the browsing ticket, in the case that the browsing ticket has been accepted, the data-reduced information being obtained by reducing data volume of the product information.

The program may further cause the computer to execute a process including: issuing the browsing ticket; and storing the issuing information, which is information regarding issuance of the browsing ticket, wherein, in the accepting of the presentation of the browsing ticket, the browsing ticket is accepted based on the issuing information.

In the computer-readable non-transitory storage medium storing a program, the program causes the computer to execute a process including: issuing the browsing ticket that serves to allow the browsing person to browse the product information; and transmitting the issued browsing ticket to the browsing person, wherein the browsing ticket includes the plurality of indexes in order to specify the product information that is the object to be browsed by the browsing person, and the plurality of indexes include the index that serves to specify a revision of the product information that is the object to be browsed by the browsing person.

In the above-described computer-readable non-transitory storage medium, the program may further cause the computer to execute a process including: acquiring the update history information, which is information concerning an update history of the product information, and generating, based on the update history information, the product information list including the list of the plurality of items of the product information the revisions of which differ from one another, wherein, in the issuing of the browsing ticket, the browsing ticket that serves to allow the browsing person to browse the product information selected from the product information list may be issued.

The present invention is not limited to the above disclosure, and various modifications are possible without departing from the essence and gist of the present invention.

What is claimed is:

1. An information browsing system, comprising:
one or more processors that execute computer-executable instructions stored in a memory, wherein the one or more processors execute the computer-executable instructions to cause the information browsing system to:
store data-reduced information obtained by reducing data volume of product information;
accept a presentation of a browsing ticket from a browsing person; and
in a case that the browsing ticket has been accepted, allow the browsing person to browse the data-reduced information corresponding to the product information specified by the browsing ticket.

2. The information browsing system according to claim 1, wherein the one or more processors further cause the information browsing system to:
issue the browsing ticket;
store issuing information, which is information regarding issuance of the browsing ticket; and
accept the browsing ticket based on the issuing information.

3. The information browsing system according to claim 1, wherein the one or more processors further cause the information browsing system to generate the data-reduced information by reducing the data volume of the product information and store the generated data-reduced information.

4. The information browsing system according to claim 1, wherein the one or more processors further cause the information browsing system to transmit the browsing ticket to the browsing person designated by a user.

5. The information browsing system according to claim 1, wherein the product information is at least one of Computer-Aided Design data, Computer-Aided Engineering data, or Computer Graphics data.

6. An information browsing system, comprising:
one or more processors that execute computer-executable instructions stored in a memory, wherein the one or more processors execute the computer-executable instructions to cause the information browsing system to:
issue a browsing ticket that serves to allow a browsing person to browse product information; and
transmit the browsing ticket to the browsing person, and
wherein the browsing ticket comprises a plurality of indexes in order to specify the product information that is an object to be browsed by the browsing person, and
the plurality of indexes include an index that serves to specify a revision of the product information that is the object to be browsed by the browsing person.

7. The information browsing system according to claim 6, wherein the one or more processors further cause the information browsing system to:
acquire update history information, which is information concerning an update history of the product information;
generate, based on the update history information, a product information list including a list of a plurality of items of the product information the revisions of which differ from one another; and
issue the browsing ticket that serves to allow the browsing person to browse the product information selected from the product information list.

8. The information browsing system according to claim 6, wherein the one or more processors further cause the information browsing system to:
store issuing information, which is information concerning issuance of the browsing ticket;
accept the browsing ticket presented from the browsing person, based on the issuing information; and
in a case that the browsing ticket has been accepted, allow the browsing person to browse the product information specified by the browsing ticket.

9. The information browsing system according to claim 6, wherein the product information is at least one of Computer-Aided Design data, Computer-Aided Engineering data, moving image data, Tagged Image File Format data, Computer Graphics data, authentication data, or Electronic Control Unit data.

10. An information browsing device, comprising:
one or more processors that execute computer-executable instructions stored in a memory, wherein the one or more processors execute the computer-executable instructions to cause the information browsing device to:
accept a presentation of a browsing ticket from a browsing person; and
in a case that the browsing ticket has been accepted, allow the browsing person to browse data-reduced information corresponding to product information specified by the browsing ticket, wherein the data-reduced information is obtained by reducing data volume of the product information.

11. The information browsing device according to claim 10, wherein the one or more processors further cause the information browsing device to:
issue the browsing ticket;
store issuing information, which is information regarding issuance of the browsing ticket; and
accept the browsing ticket based on the issuing information.

12. An information browsing device, comprising:
one or more processors that execute computer-executable instructions stored in a memory, wherein the one or more processors execute the computer-executable instructions to cause the information browsing device to:
issue a browsing ticket that serves to allow a browsing person to browse product information, and
wherein the browsing ticket comprises a plurality of indexes in order to specify the product information that is an object to be browsed by the browsing person, and
the plurality of indexes include an index that serves to specify a revision of the product information that is the object to be browsed by the browsing person.

13. The information browsing device according to claim 12, wherein the one or more processors further cause the information browsing device to:
acquire update history information, which is information concerning an update history of the product information;
generate, based on the update history information, a product information list including a list of a plurality of items of the product information the revisions of which differ from one another; and
issue the browsing ticket that serves to allow the browsing person to browse the product information selected from the product information list.

14. The information browsing device according to claim 12, wherein the one or more processors further cause the information browsing device to:
store issuing information, which is information concerning issuance of the browsing ticket;
accept the browsing ticket presented from the browsing person, based on the issuing information; and
in a case that the browsing ticket has been accepted, allow the browsing person to browse the product information specified by the browsing ticket.

15. An information browsing method, comprising:
accepting a presentation of a browsing ticket from a browsing person; and
in a case that the browsing ticket has been accepted, allowing the browsing person to browse data-reduced information corresponding to product information specified by the browsing ticket, wherein the data-reduced information is obtained by reducing data volume of the product information.

16. The information browsing method according to claim 15, further comprising:
issuing the browsing ticket; and
storing issuing information, which is information regarding issuance of the browsing ticket,
wherein, in the accepting of the presentation of the browsing ticket, the browsing ticket is accepted based on the issuing information.

17. An information browsing method, comprising:
issuing a browsing ticket that serves to allow a browsing person to browse product information; and
transmitting the issued browsing ticket to the browsing person,
wherein the browsing ticket comprises a plurality of indexes in order to specify the product information that is an object to be browsed by the browsing person, and
the plurality of indexes include an index that serves to specify a revision of the product information that is the object to be browsed by the browsing person.

18. The information browsing method according to claim 17, further comprising:
acquiring update history information, which is information concerning an update history of the product information; and
generating, based on the update history information, a product information list including a list of a plurality of items of the product information the revisions of which differ from one another,
wherein, in the issuing of the browsing ticket, the browsing ticket that serves to allow the browsing person to browse the product information selected from the product information list is issued.

19. A computer-readable non-transitory storage medium storing a program therein, wherein the program causes a computer to execute a process comprising:
accepting a presentation of a browsing ticket from a browsing person; and
in a case that the browsing ticket has been accepted, allowing the browsing person to browse data-reduced information corresponding to product information specified by the browsing ticket, wherein the data-reduced information is obtained by reducing data volume of the product information.

20. The computer-readable non-transitory storage medium according to claim 19, wherein the program further causes the computer to execute a process comprising:
issuing the browsing ticket; and
storing issuing information, which is information regarding issuance of the browsing ticket,
wherein, in the accepting of the presentation of the browsing ticket, the browsing ticket is accepted based on the issuing information.

21. A computer-readable non-transitory storage medium storing a program therein, wherein the program causes a computer to execute a process comprising:
issuing a browsing ticket that serves to allow a browsing person to browse product information; and
transmitting the issued browsing ticket to the browsing person,
wherein the browsing ticket comprises a plurality of indexes in order to specify the product information that is an object to be browsed by the browsing person, and
the plurality of indexes include an index that serves to specify a revision of the product information that is the object to be browsed by the browsing person.

22. The computer-readable non-transitory storage medium according to claim 21, wherein the program further causes the computer to execute a process comprising:
acquiring update history information, which is information concerning an update history of the product information; and
generating, based on the update history information, a product information list including a list of a plurality of items of the product information the revisions of which differ from one another,
wherein, in the issuing of the browsing ticket, the browsing ticket that serves to allow the browsing person to browse the product information selected from the product information list is issued.
